(19) United States
(12) Patent Application Publication
(10) Pub. No.: US 2025/0296457 A1
(43) Pub. Date: Sep. 25, 2025

(54) INTEGRATED BATTERY CURRENT CONTROL MODULE AND INVERTER SYSTEM CONTROLLER

(71) Applicant: Ford Global Technologies, LLC, Dearborn, MI (US)

(72) Inventor: Mohamed Elshaer, Canton, MI (US)

(21) Appl. No.: 18/613,574

(22) Filed: Mar. 22, 2024

(51) Int. Cl. B60L 53/22; B60L 53/24; H02M 1/42; H02M 7/5387

(52) U.S. Cl. CPC B60L 53/22; B60L 53/24; H02M 1/4233; H02M 7/53871; B60L 2210/42

(57) ABSTRACT

An automotive power system has a circuit arrangement including an AC/DC power factor correction circuit, a transformer, and a switch that connects the transformer to a phase leg of an electric machine between the electric machine and an inverter system controller. When the switch is closed, the circuit arrangement, electric machine, and inverter system controller form a bi-directional AC/DC-DC/AC power converter.

### TECHNICAL FIELD

This disclosure relates to automotive power systems.

### BACKGROUND

An automotive vehicle may use electrical energy to power an electric machine. The electric machine may convert this electrical energy to mechanical energy to propel the vehicle. The automotive vehicle may include various power electronics equipment to condition and store electrical energy.

### SUMMARY

A vehicle includes a traction battery, an electric machine, an inverter system controller connected between the traction battery and electric machine, and a circuit arrangement. The circuit arrangement includes an AC/DC power factor correction circuit, a transformer, a switch bridge connected between the AC/DC power factor correction circuit and transformer, and a switch that connects the transformer to a phase leg of the electric machine between the electric machine and inverter system controller such that when the switch is closed, the circuit arrangement, electric machine, and inverter system controller form a bi-directional AC/DC-DC/AC power converter.

A method includes closing a switch of a circuit arrangement to connect an AC/DC power factor correction circuit, a switch bridge, and a transformer of the circuit arrangement across an inverter system controller connected between an electric machine and a traction battery such that the circuit arrangement, electric machine, and inverter system controller form a bi-directional AC/DC-DC/AC power converter that transfers power from an AC source to the traction battery.

An automotive power system has a circuit arrangement including an AC/DC power factor correction circuit, a transformer, and a switch that connects the transformer to a phase leg of an electric machine between the electric machine and an inverter system controller. The automotive power system also has a controller that closes the switch such that the circuit arrangement, electric machine, and inverter system controller form a bi-directional AC/DC-DC/AC power converter that transfers power from an AC source to the traction battery.

### BRIEF DESCRIPTION OF THE DRAWINGS

FIG. 1 is a schematic diagram of a system including a battery current control module.

FIG. 2 is a schematic diagram of a system including an inverter system controller.

FIG. 3 is a schematic diagram of a system including a battery current control module and an inverter system controller.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Battery current control modules (BCCMs) are components in automotive vehicles, particularly those with electric or hybrid powertrains. These modules play a role in managing the flow of electric current to and from the battery. BCCMs function as control units that interface between the battery, the charging system, and the electrical loads. They monitor and control various parameters such as battery state of charge, voltage, and temperature, and based on this information, they manage the flow of current to the battery. BCCMs may facilitate charging control by overseeing the charging process of the battery and managing the voltage and current supplied by the charging system. By monitoring the battery's state of charge and adjusting the charging parameters accordingly, BCCMs attempt to ensure the battery receives the appropriate level of charge to maintain performance. Similarly, BCCMs may be responsible for discharging control. They can manage the current output from the battery to the electrical loads in the vehicle. By controlling the current flow, BCCMs may ensure a controlled supply of power to the various electrical components and systems. BCCMs may also implement various measures for the battery. For instance, they may monitor battery temperature to prevent overheating. They may also detect overvoltage or undervoltage situations and implement measures to preclude short circuits or excessive current draw. BCCMs may feature diagnostic capabilities. These modules can monitor the health and performance of the battery system. They can log codes and provide diagnostic information, facilitating maintenance.

Communication interfaces are often incorporated into BCCMs. These interfaces, such as Controller Area Network (CAN) or LIN (Local Interconnect Network), allow BCCMs to exchange information with other vehicle systems, including the engine control unit or the body control module. This enables coordinated operation and integrated control across various vehicle functions. BCCMs can receive commands or instructions from other control units and adjust current flow accordingly.

Inverter system controllers (ISCs) are also components in automotive vehicles with electric powertrains. They play a role in managing and controlling the power flow between the battery and electric motor. A function of an inverter system controller is to convert direct current (DC) from the battery into alternating current (AC) to power the electric motor. ISCs may act as a decision maker for the power electronics system. It may monitor various parameters such as motor speed, torque, and temperature to ensure operation. A task of ISCs is to convert DC power from the battery into three-phase AC power suitable for the electric motor. It may utilize high-power semiconductor devices, for example insulated-gate bipolar transistors (IGBTs), to control the switching of current and voltage. By modulating the pulse width and frequency of the AC waveform, the inverter system controller manages the speed and torque output of the electric motor. ISCs may provide control over the electric motor. They may use algorithms and control strategies to manage motor speed, torque, and direction of rotation. By adjusting the switching patterns of the IGBTs, the controller can vary the frequency and amplitude of the AC waveform, altering motor operation. ISCs can facilitate regenerative braking. During slowing or braking, the electric motor operates as a generator, converting the vehicle's kinetic energy into electrical energy. The ISC may control the flow of energy, directing it back to the battery for storage. ISCs may be responsible for managing the thermal conditions of the power electronics system. They may monitor the temperature of the inverter and electric motor, and employ cooling systems such as fans, liquid cooling, or heat sinks to dissipate excess heat and maintain operating temperatures. ISCs may incorporate diagnostic capabilities to detect and protect against faults in the power electronics system. They may monitor various parameters such as voltage, current, and temperature values that could indicate a potential fault. If a fault is detected, the controller may take corrective actions such as shutting down the system, activating other measures, or providing fault codes for diagnostic purposes. ISCs may incorporate features such as overvoltage and undervoltage monitoring, overcurrent monitoring, and isolation monitoring.

ISCs often feature communication interfaces such as CAN or Ethernet, enabling integration with other vehicle systems. They may exchange information with the main control unit, enabling coordinated operation and facilitating diagnostics and troubleshooting. Communication interfaces also allow the controller to receive commands or instructions from the electronic control unit and adjust the power output accordingly.

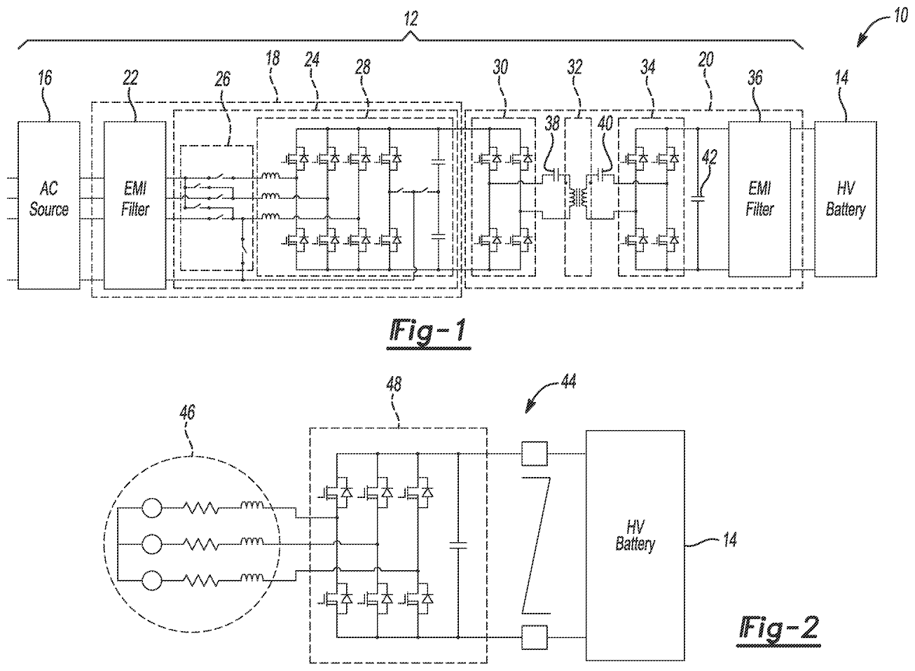

Integrating the BCCM with the ISC is conventionally considered a challenge due to the disconnecting circuitry. The schematics of typical separate systems are shown in FIGS. 1 and 2, respectively.

Referring to FIG. 1, an automotive system 10 includes an isolated AC/DC onboard charger 12 and a traction battery 14. In this example, the isolated AC/DC onboard charger 12 is connected between the traction battery 14 and an AC source 16.

The isolated AC/DC onboard charger 12 includes an AC/DC power factor correction circuit 18 (single phase/three phase) and an isolated high voltage DC/DC converter 20. The isolated high voltage DC/DC converter 20 is connected between the traction battery 14 and AC/DC power factor correction circuit 18.

The AC/DC power factor correction circuit 18 includes an electromagnetic interference filter 22 and a bidirectional totem pole power factor correction circuit 24. The bidirectional totem pole power factor correction circuit 24 includes a switch bank 26 and an AC/DC power converter circuit 28. The switch bank 26 is connected between the electromagnetic interference filter 22 and AC/DC power converter circuit 28.

The isolated high voltage DC/DC converter 20 includes a first switch bridge 30, a transformer 32, a second switching bridge 34, an electromagnetic interference filter 36, a pair of capacitors 38, 40, and a link capacitor 42. The transformer 32 is connected between the capacitors 38, 40, which are collectively connected between the first and second switching bridges 30, 34. The first switch bridge 30 is connected between the AC/DC power factor correction circuit 18 and capacitor 38. The second switching bridge 34 is connected between the capacitor 40 and link capacitor 42. The electromagnetic interference filter 36 is connected between the link capacitor 42 and traction battery 14. Power from the AC source 16 can thus flow through the isolated AC/DC onboard charger 12 to charge the traction battery 14 during operation.

Referring to FIG. 2, the system 44 includes an electric machine 46 and an ISC 48. The ISC 48 is connected between the traction battery 14 and electric machine 46.

The ISC 48 has a three-phase inverter designed to drive the electric machine 46 and operates at much higher power than the BCCM of FIG. 1. The BCCM of FIG. 1 also has an AC/DC circuit configured as a three-phase inverter/rectifier. Two disconnect circuits are required to utilize the ISC's three-phase inverter in charging/discharging the traction battery 14. The first disconnect circuit is used to disconnect the electric motor 46 from the ISC 48, and the second disconnects the ISC 48 from the traction battery 14. The contactors used in these disconnect circuits must carry the ISC's full current. Adding these contactors increases the bill-of-material-making electric-level integration unfavorable. Package-level integration, however, can provide advantages since it reduces the overall package and number of connectors and wires.

Here, a circuit topology is proposed that addresses the disconnect circuitry issue. It allows for integrating a BCCM with an ICS without using high current contractors. An add-on circuit is interfaced directly with an ISC without disconnecting an electric motor or battery. The add-on circuit includes a front-end AC/DC power factor correction circuit and portions of an isolated high voltage DC/DC circuit that is part of the BCCM. A relay is added for disconnecting the add-on circuit from the ISC inverter during drive mode. The relay is designed to handle only the BCCM current requirement. When the vehicle is plugged into an AC grid, the add-on circuitry, ISC, and electric motor form a bi-directional AC/DC-DC/AC power converter. During charging operation, the traction inverter is configured as a half-bridge: The inverter's bus capacitor is split into two capacitors. The secondary side of the transformer is interfaced between one of the inverter legs and the capacitors. The BCCM's high voltage DC/DC circuit is designed considering the electric machine's stator winding impedance and its variations with respect to the rotor position. The BCCM's high voltage DC/DC converter may be designed to switch at a frequency much higher than the ISC's switching frequency (e.g., high voltage DC/DC switch at 300 kHz and ISC switch at <30 kHz).

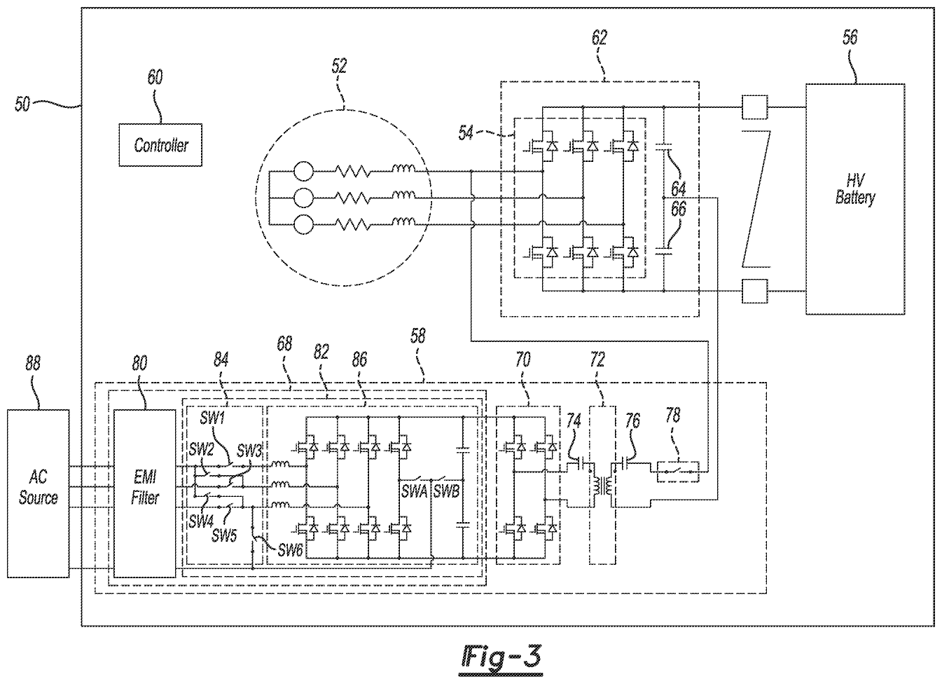

Referring to FIG. 3, a vehicle 50 includes an electric machine 52, an ISC 54, a traction battery 56, an add-on circuit 58, and a controller 60. The ISC 54 is connected between the electric machine 52 and traction battery 56. The controller 60 is in communication with/exerts control over the electric machine 52, ISC 54, traction battery 56, an add-on circuit 58.

The ISC 54 includes a plurality of switches 62 and capacitors 64, 66. The switches 62 are connected between the electric machine 52 and the capacitors 64, 66. The capacitors 64, 66 are connected in series, and between the switches 62 and traction battery 56. The series connected capacitors 64, 66 are connected in parallel with the traction battery 56.

The add-on circuit 58 includes an AC/DC power factor correction circuit 68, a switch bridge 70, a transformer 72, a pair of capacitors 74, 76, and a switch 78. The switch bridge 70 is connected between the AC/DC power factor correction circuit 68 and capacitor 74. The capacitor 74 is connected between the switch bridge 70 and transformer 72. The transformer 72 is connected between the capacitors 74, 76. The capacitor 76 is connected between the transformer 72 and switch 78. The switch 78 is connected between the capacitor 76 and a phase leg of the electric machine 52 between the electric machine 52 and inverter system controller 54. A terminal of a coil of the transformer 72 is connected between the capacitors 64, 66.

The AC/DC power factor correction circuit 68 includes an electromagnetic interference filter 80 and a bidirectional totem pole power factor correction circuit 82. The bidirectional totem pole power factor correction circuit 82 includes a switch bank 84 and an AC/DC power converter circuit 86. The switch bank 84 is connected between the electromagnetic interference filter 80 and AC/DC power converter circuit 86. The AC/DC power converter circuit 86 is connected between the switch bank 84 and switch bridge 70.

The add-on circuit 68 is connected with an AC source 88. During charge of the traction battery 56, the add-on circuit 58, electric machine 52, and ISC 54 (with the switch 78 closed) form a bi-directional AC/DC-DC/AC power converter as suggested above. 3 phase, S1, S3, and S5. During drive, the switch 78 is open.

During the charging process, switches SW1, SW2, SW3, SW4, SW5 within the switch bank are configured to enable the AC/DC power module to accept either a single-phase or three-phase input from the AC source 88. For a three-phase AC source connection, the switches SW1, SW3, SW5 are closed, thus connecting each of the three inductors in the AC/DC converter to the corresponding phases of the AC source 88. The neutral line is connected to the midpoint of the link capacitor by closing switch SWB of the AC/DC power converter circuit 86. For a single-phase input from the AC source 88, the switches SW1, SW2, SW4 are closed, with the neutral line being connected to the midpoint of the low frequency switching leg through switch SWA of the AC/DC power converter circuit 86. This setup enables the circuit within the AC/DC power factor correction circuit 68 to operate as either a single-phase or three-phase bi-directional totem pole power factor correction circuit.

The output from the AC/DC converter is routed to a bi-directional, isolated DC/DC converter circuit, initiated by engaging the switch 78. Components such as the switch bridge 70, resonant capacitors 74, 76, transformer 72, switch 78, switches 62, link capacitors 64, 66, and electric machine 52 collectively comprise a bi-directional isolated DC/DC converter. The switch bridge 70 functions as a bidirectional inverter-rectifier, converting the DC voltage from the link capacitor into a high-frequency voltage that is supplied to the resonant capacitor 74. The capacitor 74 is for matching the impedance between the inverter and transformer 72, thereby reducing reactive power and boosting efficiency. The transformer 72 provides critical galvanic isolation between the AC source 88 and the traction battery 56. The voltage at the transformer's secondary side is transferred to the capacitor 76, which then interfaces with the ISC 54. In this configuration, only one leg of the ISC 54 is employed, and it switches at the same frequency as the switch bridge 70.

Additionally, the DC link in the traction inverter is separated into the capacitors 64, 66, creating a half-bridge configuration alongside one leg from the traction inverter. When power is directed from the AC source 88 to the traction battery 56, the ISC 54 is programmed to switch only the leg that is connected to the switch 78, together with the two link capacitors 64, 66, functioning as an active rectifier. In contrast, when power is being sent from the traction battery 56 back to the AC source 88, the ISC 54, along with the two link capacitors 64, 66, act as a half-bridge inverter, enabling the flow of power in the opposite direction.

These designs ensure that the electric machine 52 does not carry the load current. This is accomplished by activating only one leg of the ISC 54, while the other two legs remain inactive, thereby managing power transfer between the AC source 88 and traction battery 56 efficiently.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. Moreover, the words used in the specification are words of description rather than limitation, and it is understood that various changes may be made without departing from the spirit and scope of these disclosed materials. The terms “controller” and “controllers,” for example, can be used interchangeably herein as the functionality of a controller can be distributed across several controllers/modules, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a traction battery;
an electric machine;
an inverter system controller connected between the traction battery and electric machine; and
a circuit arrangement including an AC/DC power factor correction circuit, a transformer, a switch bridge connected between the AC/DC power factor correction circuit and transformer, and a switch configured to connect the transformer to a phase leg of the electric machine between the electric machine and inverter system controller such that when the switch is closed, the circuit arrangement, electric machine, and inverter system controller form a bi-directional AC/DC-DC/AC power converter.

2. The vehicle of claim 1, wherein the inverter system controller includes capacitors connected in series and wherein the transformer is connected between the capacitors.

3. The vehicle of claim 2, wherein the capacitors are connected in parallel with the traction battery.

4. The vehicle of claim 3, wherein the inverter system controller further includes a plurality of switches and wherein the capacitors are connected between the switches and traction battery.

5. The vehicle of claim 1, wherein the AC/DC power factor correction circuit includes a bidirectional totem pole power factor correction circuit.

6. The vehicle of claim 5, wherein the AC/DC power factor correction circuit further includes an electromagnetic interference filter and wherein the bidirectional totem pole power factor correction circuit is connected between the electromagnetic interference filter and switch bridge.

7. The vehicle of claim 1, wherein the switch is configured to be open during a drive mode and close during a charge mode.

8. A method comprising:
closing a switch of a circuit arrangement to connect an AC/DC power factor correction circuit, a switch bridge, and a transformer of the circuit arrangement across an inverter system controller connected between an electric machine and a traction battery such that the circuit arrangement, electric machine, and inverter system controller form a bi-directional AC/DC-DC/AC power converter configured to transfer power from an AC source to the traction battery.

9. The method of claim 8 further comprising opening the switch after charge of the traction battery.

10. An automotive power system comprising:
a circuit arrangement including an AC/DC power factor correction circuit, a transformer, and a switch configured to connect the transformer to a phase leg of an electric machine between the electric machine and an inverter system controller; and
a controller programmed to close the switch such that the circuit arrangement, electric machine, and inverter system controller form a bi-directional AC/DC-DC/AC power converter configured to transfer power from an AC source to a traction battery.

11. The automotive power system of claim 10, wherein the circuit arrangement further includes a switch bridge connected between the AC/DC power factor correction circuit and transformer.

12. The automotive power system of claim 11, wherein the AC/DC power factor correction circuit includes a bidirectional totem pole power factor correction circuit.

13. The automotive power system of claim 12, wherein the AC/DC power factor correction circuit further includes an electromagnetic interference filter.

14. The automotive power system of claim 13, wherein the bidirectional totem pole power factor correction circuit is connected between the electromagnetic interference filter and switch bridge.

15. The automotive power system of claim 10, wherein the circuit arrangement further includes capacitors and wherein the transformer is connected between the capacitors.

16. The automotive power system of claim 10, wherein the controller is further programmed to open the switch after charge of the traction battery.

17. The automotive power system of claim 10, wherein the switch is a relay.
